(19) United States
(12) Patent Application Publication
(10) Pub. No.: US 2002/0005066 A1
(43) Pub. Date: Jan. 17, 2002

(54) Glow-in-the-dark tire pressure gauge

(76) Inventors: Leanne M. Tanner, Woodinville, WA (US); Kelly J. Tanner, Woodinville, WA (US)

Correspondence Address: STEVEN G. LISA, LTD., Suite 300, 14614 North Kierland Boulevard, Scottsdale, AZ, 85254, US

(21) Appl. No.: 09/962,960

(22) Filed: Sep. 24, 2001

Related U.S. Application Data
(63) Continuation of application No. 08/808,889, filed on Feb. 28, 1997.
Application No. 08/808,889 is a continuation of application No. 08/574,947, filed on Dec. 19, 1995, now abandoned.

(51) Int. Cl. G01M 17/02

(52) U.S. Cl. 73/146

(57) ABSTRACT

A dial-type tire pressure gauge uses a glow-in-the-dark material to illuminate the pressure indication scale so that it is highly visible even in inadequate lighting conditions. The gauge includes a face plate that is either coated or formed of glow-in-the-dark material. A contrasting pressure scale is superimposed over the glow-in-the-dark face plate. After exposing the glow-in-the-dark material to heat or light, the face plate will luminesce for an extended period of time, allowing a user to read the pressure scale in inadequate light conditions without an auxiliary light source.

### BACKGROUND

The present invention relates to the field of tire pressure measuring devices, and more specifically, to tire pressure measuring devices that use glow-in-the-dark substances for illumination to allow for taking quick, efficient, and accurate readings in a variety of lighting conditions, and more particularly, tire pressure measuring devices for use in night time motorsports events.

Tire pressure gauges in a variety of forms have been used for a number of years. The most common tire pressure gauges include dial-type gauges and scale-ruler-type gauges, such as those disclosed in the following U.S. Pat. Nos. 3,999,439, 4,028,936, 4,501,142, 4,574,629, 4,884,175, 4,927,629, 4,916,944, 4,966,035 and 5,339,683. In more recent years, digital tire pressure gauges were developed, such those disclosed in U.S. Pat. Nos. 4,998,438 and 5,168,751. Tire pressure gauges were also combined with other devices such as the tire inflation systems disclosed in U.S. Pat. Nos. 4,658,869 and 5,325,886, and tire stem valve caps or tire stems disclosed in U.S. Pat. Nos. 4,464,929, 4,763,516, 4,793,177 and 5,103,670. All of the above patents are incorporated herein by reference.

Pneumatic tires are used on a wide variety of vehicles. In most applications, it is recommended to maintain proper tire pressure to provide a more comfortable ride, longer tread wear, optimum performance and greater safety. In certain high performance applications, such as those involving airplanes, long distance heavy hauling and motorsports, maintaining proper tire pressure is critical. In those high performance applications, safety and efficiency are of paramount importance. However, lighting conditions in those critical applications are often inadequate, making it very difficult to accurately use and read conventional tire pressure gauges.

For example, in motorsport racing, adjusting or varying tire pressure settings is a primary form of altering or controlling the handling characteristics of the racing vehicle. Increasing or decreasing tire pressures by even a small amount can have a large impact on the balance of all types of race cars. In many instances, tire pressures are intentionally changed during a racing event to compensate for changing track conditions or weather. In the extreme, such changes are required to be made accurately and quickly in a matter of seconds during a pit stop. More commonly, however, in most racing applications, race tires are slightly over-pressurized before installation on the racecar, and then the excess pressure is bled off immediately prior to installation. In that manner, the tire pressure is precisely set at the temperature conditions that most accurately reflect racing conditions. Thus, in motorsports events it is required to frequently and accurately read tire pressures to within a fraction of a pound.

To make accurate pressure readings while bleeding down pressure, most race teams use a precision tire pressure gauge similar to the one shown in U.S. Pat. No. 3,999,430, incorporated herein by reference. To use this type of precision tire pressure gauge, the operator uses one hand to hold the tire pressure chuck or nozzle onto the valve stem of the tire, and uses the other hand to hold a dial type gauge in a position to be read. Incorporated into the gauge is a bleed off valve. The hand holding the gauge is also used to activate the bleeder valve to release air until the desired pressure is reached. Thus, two hands are necessary to operate the preferred form of precision tire pressure gauge used in the racing application.

However, many motorsport events (e.g., endurance, sprint car, stock car, and off road racing) occur or extend into the evening hours when lighting is inadequate. Also, at many racing events, electrical outlets are not often available at the racetrack or in the pits for use by the pit crew. Moreover, even when electricity is available, electric tools and lights are not typically authorized for use in the pit areas, where the need for fast, efficient maintenance along with safety concerns requires the minimization of excess equipment such as flashlights, lights, or extension cords. In any event, the preferred form of tire pressure gauge already requires two hands for proper operation, making it impractical to hold another source of light. The absence of electricity and inadequate lighting conditions, combined with the need for fast and precise tire pressure measurements, presents a serious problem to most motorsports teams.

As a result, several attempts have been made in the past to overcome some of the problems associated with trying to read a tire pressure gauge in the dark. For example, a tire pressure gauge has been combined with a light or electroluminescence displays, as shown in U.S. Pat. Nos. 4,884,175; 5,148,704; 5,435,173; and 5,435,174. Another example is U.S. Pat. No. 5,339,683, which incorporates an audible alarm to warn of an over-pressure situation.

However, each of these solutions suffer from the need to ensure that a power source, such as a battery, is working properly. This requirement creates the inconvenience and expense of having to continuously check and replace batteries. Furthermore, batteries are often unreliable. They can leak or lose their charge when left in racecar transporters or trailers, glove compartments, and tool boxes, or when left in hot weather for long periods of time. Batteries can also fail if a short develops, if they can become discharged, or if someone forgets to turn the device off. Battery operated devices are also typically bulkier and require the activation of a switch, adding burdens to a task that already requires the use of two hands.

In short, prior attempts to provide a light source of any form with a tire pressure gauge are not ideally applicable to the motorsports application, where precision, speed, safety, ease of use and reliability are all of paramount importance. In motorsports events, the untimely failure of even a simple tire pressure gauge, or an incorrect pressure reading, can mean the difference between winning and losing an event.

As a result, in the motorsports and other high performance applications, a need exists for a self lighting, non-electric, precise, highly reliable, and portable tire pressure gauge that can be read easily under a variety of lighting conditions. That need is solved by providing a high performance tire pressure gauges that incorporates glow-in-the-dark materials to illuminate the pressure indications.

In that regard, glow-in-the-dark materials such as phosphorescent, fluorescent or luminescent materials, have in the past taken on a variety of forms, including those described in the following U.S. patents which are incorporated herein by reference: inks in U.S. Pat. Nos. 3,867,302, 4,089,995, 4,302,487, 4,525,295 and 5,100,580; molded plastics in U.S. Pat. Nos. 4,629,583, 4,640,797 and 4,928,212; sheets or films in U.S. Pat. Nos. 3,873,390, 5,237,448, 5,300,783 and 5,374,377, fibers or fabric in U.S. Pat. Nos. 4,421,813, 4,546,042, 4,623,579 and 5,321,069; various phosphorescent phosphors and luminescent compounds in U.S. Pat. Nos. 5,230,831, 5,273,732, 5,376,303, and 5,424,006; and colored phosphorescent materials in U.S. Pat. Nos. 5,270,100 and 5,271,754.

Glow-in-the-dark materials have been used to make many items easier to use or locate in poor lighting and sometimes for novelty purposes. Some of these items are described in the following U.S. patents: watches and watchbands in U.S. Pat. Nos. 4,285,055, 4,641,925, 4,910,652, 5,086,418 and 5,426,621; golf balls in U.S. Pat. Nos. 5,007,647, 5,228,697 and 5,330,195; non-slip surfaces in U.S. Pat. Nos. 4,360,557, 4,522,861, and 5,395,673; liquid cleansers in U.S. Pat. No. 5,427,708; compasses in U.S. Pat. Nos. 4,899,453 and 5,367,781; highway barricades in U.S. Pat. No. 3,952,690; road warning signals in U.S. Pat. No. 5,303,668; traffic lane markers in U.S. Pat. Nos. 4,875,799 and 5,013,181; self adhesive labels in U.S. Pat. No. 5,279,058; marker buoys in U.S. Pat. No. 5,376,035; foam seine floats for fishing nets in U.S. Pat. No. 4,501,564; fishing floats in U.S. Pat. No. 4,856,219; fishing lures or baits in U.S. Pat. Nos. 3,935,659, 4,516,350, 4,621,447, 4,803,793 and 5,063,703; toys in U.S. Pat. Nos. 4,590,381, 4,781,647 and 4,897,069; luggage tags in U.S. Pat. No. 4,901,462; door knob locators in U.S. Pat. Nos. 4,981,314 and 5,008,551; keyhole indicators in U.S. Pat. Nos. 4,914,554 and 4,981,314; key identifiers in U.S. Pat. No. 4,188,741; valve stem caps in U.S. Pat. Nos. 4,928,212; and 5,053,930; infant care articles, pacifiers, bottles, clothing, etc. in U.S. Pat. No. 4,943,896; key pads in U.S. Pat. No. 5,073,843; diving belts in U.S. Pat. No. 4,798,497; cake decorations in U.S. Pat. No. 4,416,075; textile labels in U.S. Pat. No. 4,880,256; exit signs and escape route indicators in U.S. Pat. Nos. 4,401,050, 4,420,898, 4,466,208 and 5,415,911; lights and flashlights in U.S. Pat. Nos. 4,052,610, 4,242,724, 4,245,282, 4,421,953, 4,528,621 and 4,546,416; shoes in U.S. Pat. Nos. 4,629,583 and 4,712,319; id cards in U.S. Pat. Nos. 4,151,667 and 4,219,599; sports nets and fencing in U.S. Pat. No. 5,307,578; phosphorescent markers in U.S. Pat. No. 5,116,533; artwork in U.S. Pat. No. 5,149,568; combination locks in U.S. Pat. No. 4,671,084; welt cords in U.S. Pat. No. 4,724,327; microsurgical knives in U.S. Pat. No. 4,414,974; luminescent backing sheets for writing in the dark in U.S. Pat. Nos. 3,879,611; 3,978,340; and 4,035,652; illuminated lens cases in U.S. Pat. No. 5,440,458; and reading assisting devices in U.S. Pat. No. 5,189,445.

However prior to the subject invention, glow-in-the-dark materials have not been used with tire pressure gauges. This is likely due to the fact that prior attempts to deal with reading tire pressure gauges in the dark viewed electricity as being the solution to the problem, whereas the present invention views electricity as being yet another problem.

### SUMMARY OF THE INVENTION

It is an object of this invention to provide a new and improved tire pressure measurement device that is easily read in a variety of lighting conditions.

Another object of the invention to provide a low maintenance tire pressure gauge that can be read in the dark without the use of electricity or batteries.

Another object of the invention is to provide a portable hand-held tire pressure gauge that glows in the dark so as to eliminate the need for another source of light when used in the dark.

Another object of the invention is to provide a tire pressure gauge that can be easily used at night and that does not have an on and off switch.

Another object of the invention is to provide an improved tire pressure gauge designed for the motorsports industry that eliminates the need for extraneous equipment such as electrical cords or flashlights, yet still enables efficient, accurate and fast tire pressure readings where lighting is inadequate.

Another object of the invention is to provide a compact, hand held tire pressure gauge which glows in the dark, can be quickly and accurately read and is not prone to failure.

Another object of the invention is to provide a portable hand held luminescent tire pressure gauge that can be easily read in the dark and can be recharged by exposure to either light or heat.

The above and other objects are achieved through the adaptation of a variety of glow-in-the dark materials on a tire pressure gauge so that it can be read easily in poor lighting conditions without the need for electricity.

The above and other objects are further achieved by an improved tire pressure measuring device comprising a tire pressure gauge having a pressure indicator that has a face composed of a glow-in-the-dark material with contrasting pressure indications.

The above and other objects are further achieved by an improved tire pressure measuring device comprising a tire pressure gauge having a pressure indicator that has pressure indications and a pointer composed of a glow-in-the-dark material and a contrasting face.

The above and other objects are further achieved by an improved tire pressure measuring device consisting of a dial type pressure gauge having a face and a pressure inlet. A pointer is pivotally mounted on the face of the gauge and serves to indicate pressure. The gauge face is provided with a coating that glows in the dark for a period of time after being exposed to heat or light. Contrasting pressure scale indications are superimposed on the glow in the dark gauge face. A nozzle or chuck is adapted for a quick connection to and fluid communication with the outlet from the valve stem of a standard tire or tire-tube combination, and is coupled to the pressure inlet of the pressure gauge. The pointer and pressure scale indications are visible on the glowing dial face, even in inadequate light conditions.

The above and other objects are achieved by the method of using a new and improved tire pressure gauge. The pressure gauge is energized by the application of either light or heat energy for a period of time to the glow-in-the-dark portion of the tire pressure gauge. Then, when it is necessary to make a reading, the pressure gauge is held in one hand, while a nozzle or chuck is applied to the valve with the other hand. Tire pressure readings are then clearly visible, even in poor lighting, due to the glow from the glow-in-the-dark material.

### DESCRIPTION OF THE DRAWINGS

FIG. 1 shows a plan view of a dial-type of tire pressure gauge according to the teachings of this invention;

FIG. 2 is a block diagram representation of the preferred method of manufacturing the face of the dial-type pressure gauge of FIG. 1.

FIG. 3 shows a plan view of a scale-ruler type of tire pressure gauge according to the teachings of this invention.

### DESCRIPTION OF THE PREFERRED EMBODIMENT

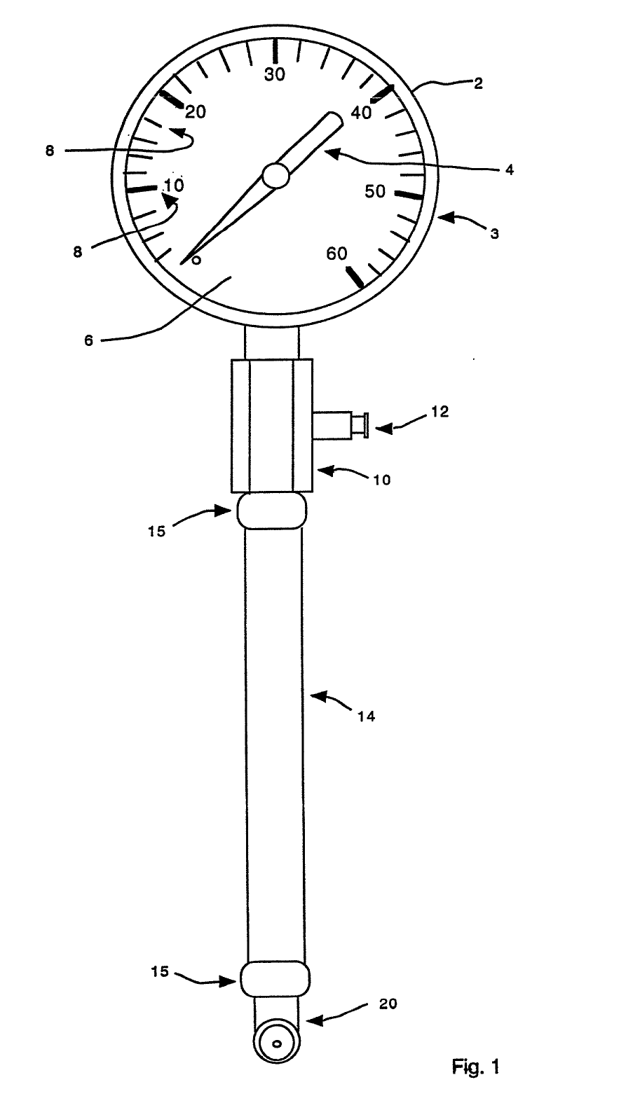

FIG. 1 shows a dial type tire pressure gauge similar to that disclosed in U.S. Pat. No. 3,999,430, incorporated by reference above. The tire pressure gauge of FIG. 1 comprises a dial-type pressure indicator such as pressure gauge 2, which can be a Bourdon-tube pressure gauge like those designated as specification number 164310 from Ametek/U.S. Gauge Division, of Hunter Spring Products, located in Bartow, Fla. In a preferred embodiment, a protective bumper 3, which can be composed of an elastomer or rubber such as the No-Shok™ boot available from Brannom Instruments of Seattle, Wash., surrounds the circumference of pressure gauge 2. A pointer 4 on gauge 2 is pivotally mounted at the center of a circular or other shaped face 6 having pressure level indications 8 marked thereon. In an alternative embodiment, the pressure level indications could be marked on plastic, glass, or other substantially transparent component that is located above the gauge face, so that the pressure level indications are read against the background of the gauge face. Any appropriate pressure indication scale can be used, depending on the application and the calibration of the gauge. For example, trucking applications would require a relatively broad scale with high limits, whereas racing applications often use scales from 0 to 15, 0 to 30 psi or 0 to 60 psi.

In its preferred form, face 6 is comprised of a glow-in-the-dark material, while the pressure level indications 8 are marked on face 6 in a black or another dark color. Ideally, multiple coats of a glow-in-the dark ink similar to USR Metal's Optonix number 2330 LBY halicon phosphorescent pigment are successively screen printed onto the metal plate of the face 6. Alternatively, face 6 may be manufactured using other glow-in-the-dark inks or materials such as the molded plastics, thin film, sheets, and fiber materials as described and incorporated by reference above. For example, U.S. Pat. No. 3,973,390, incorporated herein by reference, discloses a phosphorescent sheet or film product, and a method of manufacturing the same, that may be used for instrument dial faces. Typically, either light or heat energy is applied to the dial face 6 to cause the glow-in-the-dark material glow in the absence of light. However, it is expressly noted that the specific type of glow-in-the-dark material is not important, as long as it can be applied to the face 6, or alternatively, the face 6 can be formed from it.

A pressure relief valve 10 is incorporated to allow the bleeding of pressure from the tire. Preferrably, the valve 10 comprises a chrome plated metal bleeder valve and barb fitting such as that manufactured by the Amflo Division of Bridge Products, of Muskogee, Okla. Alternatively, the valve 10 may comprise any appropriate pressure relief valve, including the pressure maintenance and relief valve disclosed in U.S. Pat. No. 3,999,430. The valve 10 includes an air release button 12 mounted on the side thereof, and is coupled to and in fluid communication with the standard male gauge connector located on the rim of the gauge 2. A length of flexible hose 14 is used to allow the gauge 2 to be held remotely from the valve stem of the tire during the pressure reading operation. Preferrably, the hose 14 comprises a high pressure fabric hose having a rubber or teflon lining, such as that manufactured by Amazon Hose and Rubber, of Chicago, Ill. Hose 14 includes aluminum ferrules 15, such as those manufactured by Globe Products, of Ennis, Tex. The ferrules 15 are crimped on both ends of the hose 14. One of the ferrules 15 is coupled to and in fluid communication with the other end of the valve 10. A nozzle formation 20, such as a brass tire chuck available from Wilmar Tools of Seattle, Wash., has one end connected to and in fluid communication with the flexible hose 14. The other end of chuck or nozzle formation 20 is adapted for quick sealed connection to and fluid communication with the outlet from the valve stem of a standard tire or tire-tube combination. If desired, standard barbed fittings (not shown) such as those manufactured by Couplings, Inc. of Linconshire, Ill. can be used to couple the hose to the valve 10 and the nozzle formation 20.

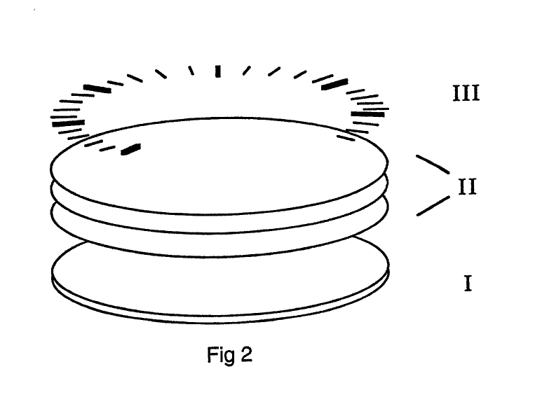

FIG. 2 is a graphical block diagram representation of the preferred method of manufacturing the face and pressure indications on a dial-type gauge shown in FIG. 1. Step I comprises the act of selecting a suitable backing material for face 6, such as a 2½″ round steel sheet. Step II comprises the act of applying a suitable glow-in-the-dark material to the face 6, for example, by silkscreen printing at least one, but preferably multiple, layer(s) of glow-in-the-dark ink similar to USR Metal's Optonix number 2330 LBY halicon phosphorescent pigment. Each of three layers of glow-in-the-dark ink are represented at Step II of FIG. 2. Shown at Step III is the act of applying a pressure scale or comparable indications 8, preferably by silkscreen printing the indications over the glow-in-the-dark material of the face 6. The indications of pressure 8 preferably comply with the standards set forth in ANSI B40.1-1980, entitled “Gauges—Pressure Indicating Dial Type—Elastic Element,” and particularly to 3.3.2, entitled “Dials.”

As indicated above, alternative materials can be used to cause the face 6 to glow in the dark. Additionally, the pressure indications can be applied to other than the face 6, for example, to a glass covering of the gauge 2. Furthermore, it is possible that the pressure scale or indications 8 and the dial or needle 4 can be comprised of glow-in-the dark material and the face 6 can be defined by a contrasting color or material.

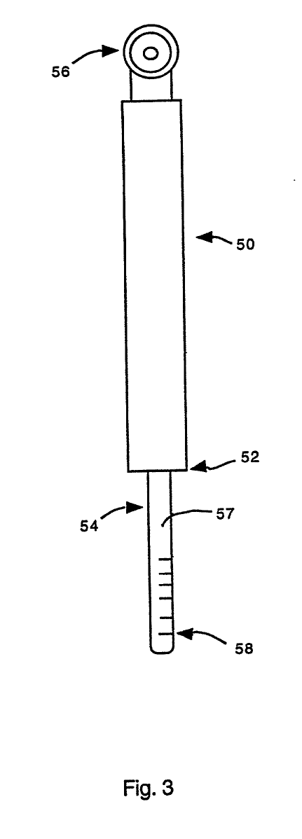

FIG. 3 shows an alternative embodiment which incorporates a scale-ruler type of tire pressure gauge, such as the rod-type pressure indicators disclosed in U.S. Pat. Nos. 4,028,936, 4,501,142, 4,574,629 (FIG. 3), U.S. Pat. No. 4,574,629 (FIGS. 1 and 2) and U.S. Pat. No. 4,966,035, each of which was incorporated by reference above. In this alternative embodiment, the tire pressure gauge of FIG. 3 comprises a housing 50 having a tail end 52 where a rectangular hole (not shown) is furnished, through which a pressure indicator 54 can move back and forth like a piston in a cylinder. At the opposite end of housing 50 there is a tire chuck or nozzle formation 56 that is adapted for quick sealed connection to and fluid communication with the outlet from the valve stem of a standard tire or tire-tube combination. The pressure indicator has at least one surface or face 57 having pressure level scale or other indications 58 marked thereon. In the preferred form, at least the face of pressure indicator 54 is composed of a glow-in-the dark material, whereas the pressure level indications 56 are comprised of black or other colored markings. Specifically, the pressure indicator 54 can be molded of plastic glow-in-the-dark material, such as shown in U.S. Pat. Nos. 4,629,583, 4,640,797 and 4,928,212, incorporated by reference above.

It will be apparent to those skilled in the art that the present invention has a number of advantages over the prior art, especially in evening motorsports activities. The present invention allows for accurate readings and precise tire pressures even when lighting is inadequate. Another advantage is that the present invention does not require a source of electricity, but instead may be recharged through the application of light or heat. Yet another advantage of the present invention is that it eliminates the need for flashlights, which are difficult to use while also using a tire pressure gauge that requires two hands to operate.

While the present invention has been described in connection with what is presently considered to be the most practical and preferred embodiments, it is to be understood that the invention is not to be limited to the disclosed embodiments but on the contrary, is intended to cover various modifications and equivalent arrangements included within the spirit and scope of the description and appended claims, which scope is to be accorded the broadest interpretation so as to encompass all such modifications and equivalent arrangements. It should be understood that details of the construction shown may be altered or omitted without departing from the spirit of the invention as defined by the following claims.

For example, if any element of an appended claim is addressed to a function that is individually well known in the prior art, and is nonetheless construed as being expressed as a means or step for performing that function without the recital of structure, material or acts in support thereof, then such a claim element shall be construed to cover any and all possible structures, materials or acts for performing that function, including later-developed equivalents thereof, and should not be construed as limited only to the corresponding structure, material or acts shown in the specification.

What is claimed is:

1. An self-illuminating device for measuring air pressure in a tire comprising:
(a) a pressure gauge responsive to air pressure in the tire, and including a pressure indicator;
(b) a valve stem adaptor coupled to and in fluid communication with the pressure gauge, and including a valve stem connector constructed to open a tire valve on the tire to communicate the air pressure inside of the tire to the pressure gauge; and wherein
(c) the pressure indicator is comprised of a contrasting pressure indication scale superimposed over a glow-in-the-dark background so that when viewed in the dark, the pressure indication scale is readily discernable.

2. The device of claim 1 wherein the pressure gauge is a dial-type gauge and wherein the pressure indicator includes an indicating dial that moves relative to the pressure scale in response to the amount of air pressure in the tire.

3. The device of claim 2 wherein the pressure indicator comprises a plate covered with a glow-in-the-dark material.

4. The device of claim 3 wherein the glow-in-the-dark material comprises a layer of ink including a phosphorescent pigment applied to the plate.

5. The device of claim 4 wherein the layer of ink is screen printed onto the surface of the plate.

6. The device of claim 5 further comprising multiple layers of ink screen printed onto the surface of the plate.

7. The device of claim 3 wherein the glow-in-the-dark material comprises a sheet including a phosphorescent pigment applied to the plate.

8. The device of claim 3 wherein the plate is comprised of a plastic molded at least in part of glow-in-the-dark materials.

9. The device of claim 3 wherien the pressure scale is comprised of dark indications printed on a glass covering over the gauge.

10. The device of claim 1 wherein the pressure gauge is a scale-ruler-type gauge.

11. The device of claim 10 wherein the pressure indicator comprises a rod configured to slide in the gauge in response to the amount of pressure communicated through the valve stem adaptor, and wherein the pressure indicator includes a ruler-type scale along at least one of the faces of the rod.

12. The device of claim 11 wherein the glow in the dark material is formed by molding the rod at least in part of glow-in-the-dark material, and wherein the contrasting pressure indicating scale is printed over the glow-in-dark material.

13. The device of claim 11 wherein the glow in the dark material is formed by covering the rod with ink that glows in the dark, and wherein the contrasting pressure indicating scale is printed over ink.

14. The device of claim 11 wherein the glow-in-the-dark material is formed by covering the rod with a sheet that glows in the dark, and wherein the contrasting pressure indicating scale is printed over the sheet.

15. The device of claim 6 further comprising a pressure relief valve in fluid communication between the gauge and the valve stem adapted to allow the release of air pressure from inside the tire.

16. The device of claim 15 further comprising a flexible hose coupled between the gauge and the valve stem adaptor.

17. An improved pressure measuring device comprising:
a) a dial-type pressure gauge having a face and a pressure inlet, the face having a visible glow in the dark surface;
b) at least one indicia of pressure that contrasts with the glow in the dark surface of the face; and
d) a nozzle formation coupled to the inlet of the pressure gauge, the nozzle formation being adapted for quick connection to and fluid communication with the outlet from a tire valve stem.

18. The pressure measuring device of claim 17 wherein the glow in the dark surface is printed onto the gauge face.

19. The pressure measuring device of claim 17 wherein the glow in the dark surface is formed by fabricating the gauge face of plastic formed at least in part of glow in the dark material.

20. The pressure measuring device of claim 17 further comprising a hand-operated pressure relief valve coupled to the nozzle.

21. The pressure measuring device of claim 17 wherein the indicia of pressure are printed over the glow in the dark face of the gauge.
